(19) United States
(12) Patent Application Publication
(10) Pub. No.: US 2021/0014363 A1
(43) Pub. Date: Jan. 14, 2021

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: Ruriko Kawano, Kawasaki-shi (JP)

(21) Appl. No.: 16/925,430

(22) Filed: Jul. 10, 2020

(30) Foreign Application Priority Data
Jul. 10, 2019 (JP) 2019-128270

(51) Int. Cl. H04N 1/00; G06F 16/587; G06F 16/58; G06F 16/51

(52) U.S. Cl. CPC H04N 1/00153; H04N 1/00161; G06F 16/51; G06F 16/5866; G06F 16/587

(57) ABSTRACT

A method of controlling an information processing apparatus according to an embodiment of the present disclosure includes a step of downloading an image which a user selects on a social networking service, from a server apparatus that provides the social networking service, a step of replacing the downloaded image with an image that corresponds to the downloaded image and is stored in the information processing apparatus, and a step of analyzing the replaced image.

### FIELD

The present disclosure relates to an information processing apparatus, a method of controlling the information processing apparatus, and a storage medium for creating photo album.

### DESCRIPTION OF THE RELATED ART

There have been cases in which a user creates a photo album using images that the user took with his/her digital camera, smartphone, or the like or using images downloaded from an SNS (social networking service). There are also cases in which image processing is performed on images that the user selects so that the images can look better on the photo album.

For example, Japanese Patent Laid-Open No. 2016-48845 discloses a technique in which in a case where images downloaded from an SNS are printed, more suitable image processing is performed considering third-party evaluation information on the SNS.

However, some SNSs, for example, decrease the resolution of images to improve the upload speed of the images, or delete or modify the Exif information to hide personal information. In the case where the images downloaded from such an SNS are used to create a photo album, the resolution of images is low, or appropriate image processing cannot be performed. As a result, the image quality of the photo album is low.

### SUMMARY

An object of the present disclosure is to suppress degradation of the image quality of the photo album.

In a first aspect of the present disclosure, there is provided a method of controlling an information processing apparatus, the method comprising the steps of: downloading an image which a user selects on a social networking service, from a server apparatus that provides the social networking service; replacing the downloaded image with an image that corresponds to the downloaded image and is stored in the information processing apparatus; and analyzing the replaced image.

In a second aspect of the present disclosure, there is provided an information processing apparatus comprising: a downloading unit configured to download an image which a user selects on a social networking service, from a server apparatus that provides the social networking service; a replacing unit configured to replace the downloaded image with an image that corresponds to the downloaded image and is stored in the information processing apparatus; and an analyzing unit configured to analyze the replaced image.

In a third aspect of the present disclosure, there is provided a non-transitory computer readable storage medium storing a program for causing a computer of an information processing apparatus to function as: a downloading unit configured to download an image which a user selects on a social networking service from a server apparatus that provides the social networking service; a replacing unit configured to replace the downloaded image with an image that corresponds to the downloaded image and is stored in the information processing apparatus; and an analyzing unit configured to analyze the replaced image.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a system for creating/ordering photo albums in a first embodiment;

FIG. 2 is a diagram illustrating a hardware configuration example of an information processing apparatus in the first embodiment;

FIG. 3 is a flowchart showing a photo-album creation process in the first embodiment;

FIG. 4 is a diagram illustrating an example of a product component selection screen in the first embodiment;

FIG. 5 is a diagram illustrating an example of a photograph selection screen in the first embodiment;

FIG. 6 is a diagram illustrating an example of an SNS login screen in the first embodiment;

FIG. 7 is a diagram illustrating another example of a photograph selection screen in the first embodiment;

FIG. 8 is a flowchart showing an image replacement process in the first embodiment;

FIG. 9 is a flowchart showing an image search process in the first embodiment;

FIG. 10 is a flowchart showing an image replacement process in a second embodiment;

FIG. 11 is a flowchart showing an image search process in the second embodiment;

FIG. 12 is a flowchart showing a similar-image obtaining process in a third embodiment; and

FIG. 13 is a diagram illustrating an example of a correspondence-image selection screen in the third embodiment.

### DESCRIPTION OF THE EMBODIMENTS

Hereinafter, preferred embodiments of the present disclosure will be described in detail with reference to the attached drawings. The following embodiments are not intended to limit the present disclosure according to the claims. In addition, the combination of all the features described in each embodiment below is not necessarily indispensable for the present disclosure.

### First Embodiment

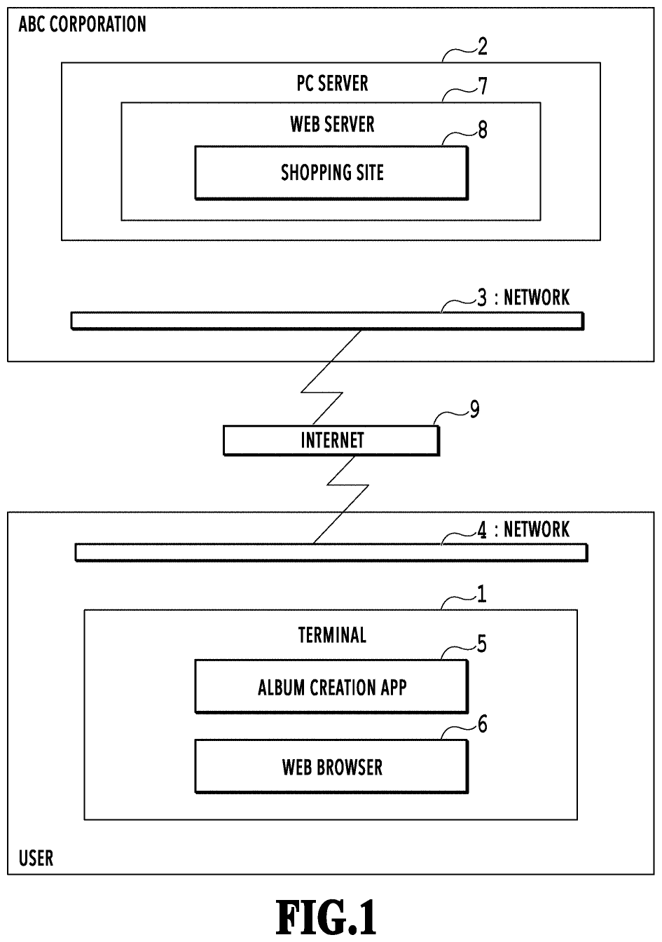

FIG. 1 is a configuration example of an information processing system in the present embodiment for creating/ordering a photo album. As shown in the illustration, the information processing system includes an information processing apparatus 1 used by a user and an information processing apparatus 2 for the company that creates photo albums. The information processing apparatus 1 may be a terminal apparatus such as a smartphone or a tablet. The information processing apparatus 1 may also be another type of apparatus, for example, a typical desktop personal computer (which may hereinafter be abbreviated as a PC), a notebook PC, an image processing apparatus such as a printer, or a KIOSK terminal. The information processing apparatus 2 may be, for example, a PC server. In the information processing apparatus 1, for example, Windows (registered trademark) 8 or the like is installed as an operating system (hereinafter referred to as an OS). In the information processing apparatus 2, for example, Windows Server 2012 or the like is installed as an OS. The information processing apparatus 1 and the information processing apparatus 2 are connected to respective networks 3 and 4 using Ethernet (registered trademark) and further communicably connected to each other via the Internet 9.

The information processing apparatus 1 has a photo-album creation application (hereinafter referred to as an album creation app) 5 installed. The album creation app 5 is constituted of, for example, an executable file (*.EXE) for Windows. The album creation app 5 functions in a case where the information processing apparatus 1 executes the executable file.

The information processing apparatus 1 also has a web browser application (hereinafter referred to as a web browser) 6 installed. The web browser 6 is used for using the World Wide Web (hereinafter, referred to as the WWW).

Note that the album creation app 5 is not limited to ones installed in advance in the information processing apparatus 1 but may be an application that is executed on the web browser 6. In this case, the program is loaded by accessing a specified website.

The network 4 is a network for the user who uses the information processing apparatus 1, which is, for example, a home network for an ordinary household.

The information processing apparatus 2 includes a web server 7 with a function of a web server and provides a website of the company (referred to as ABC corporation) via the Internet 9. The network 3 is, for example, an office network established in the company.

The shopping site 8 is a shopping site through which ABC corporation provides service for the users. The users can order photo albums using the shopping site 8.

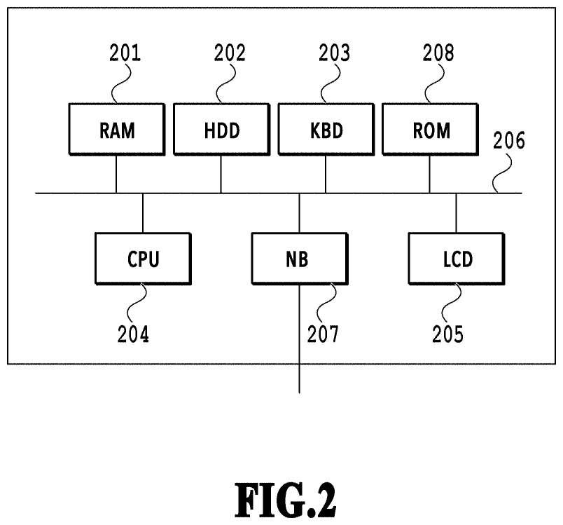

FIG. 2 illustrates a hardware configuration example of the information processing apparatus 1 and the information processing apparatus 2 in the present embodiment. As shown in the illustration, the information processing apparatus has a CPU 204, ROM 208, RAM 201, an HDD 202, a KBD 203, an LCD 205, and an NB 207, and these constituents are connected via a bus 206.

The CPU (central processing unit) 204 reads a control program stored in the ROM 208 or the HDD 202 and load into the RAM 201 to execute it. The CPU 204 is a control unit that controls the entire operation of the information processing apparatus.

The RAM 201, which is random access memory, provides a temporary storage area at the time when the CPU 204 executes the control program.

The ROM 208 stores the control program executed by the CPU 204.

The HDD (hard disk drive) 202 is a storing unit that stores image data, processing results of image analysis, and the like. The HDD 202 also stores programs such as the album creation app 5 and the web browser 6.

The KBD (keyboard) 203 is an event board unit. Specifically, it is an input unit for user operations. The KBD 203 may include another input apparatus such as a mouse. Alternatively, the KBD 203 may be a touch panel integrated with the LCD 205 described later. Generally, terminal apparatuses such as smartphones and tablets include a touch panel. The users can input instructions to the information processing apparatus via various screens provided by the album creation app 5 or the web browser 6.

The LCD (liquid crystal display) 205 is a display of the information processing apparatus. Note that the display is not limited to a liquid crystal display but may be a different type of display.

The NB (network board) 207 is a communication control unit which is an apparatus for communicating with external apparatuses such as printers and servers.

Although hardware configuration example of the information processing apparatus has been described as above, the configuration is not limited to this example.

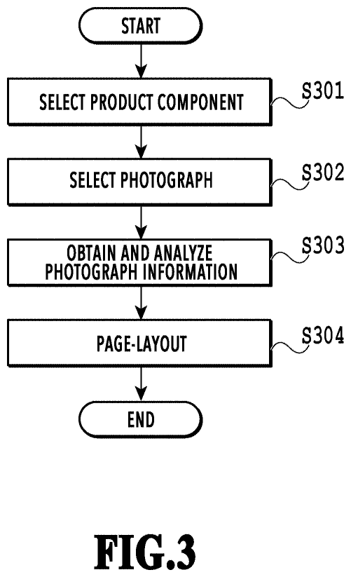

FIG. 3 is a flowchart showing a photo-album creation process in the present embodiment. A series of processes illustrated in the flowchart is performed by the CPU 204 deploying, in the RAM 201, the control program or the album creation app 5 store in the ROM 208 or the HDD 202 and executing it. Alternatively, part of the steps in the flowchart or all the functions of the flowchart may be implemented in hardware such as an ASIC or an electronic circuit. The symbol “S” at each process description means “step” in the flowchart. The same is true of the other flowcharts.

At S301, the information processing apparatus 1 displays a product component selection screen for the user to select product components for an album and obtains the product components selected by the user.

At S302, the information processing apparatus 1 displays a photograph selection screen for selecting photographs to be included in the album and obtains the image data of the photographs selected by the user. For example, in a case where the image data is stored in a certain folder in the information processing apparatus 1, the user may select the folder.

At S303, the information processing apparatus 1 obtains photograph information such as the shooting date and time and the shooting locations from the image data of the photographs selected by the user and performs analysis of the photograph information. The photograph information such as shooting date and time and shooting locations can be obtained from Exif information of image data. Specifically, by the analysis, the information processing apparatus 1, for example, arranges image data pieces in time series based on the shooting date and time or divides image data pieces into groups. The information processing apparatus 1 also evaluates image data pieces and sets scores to them.

At S304, the information processing apparatus 1 performs a page-layout for the album based on the analysis results at S303 and generates album data. Specifically, in a case where images are arranged in the slots of a template, the information processing apparatus 1, for example, arranges images in the slots in time series or arranges images with higher scores in larger slots in a template. In the layout process, the information processing apparatus 1 may arrange all the images that were analyzed (the images selected by the user) or may arrange only images with higher scores.

The generated album data is displayed on the LCD 205. The album data is also transmitted to the information processing apparatus 2 via the Internet 9. The information processing apparatus 2 uses the received album data to generate print data, which can be printed with a printing apparatus to make a bound photo album using paper media.

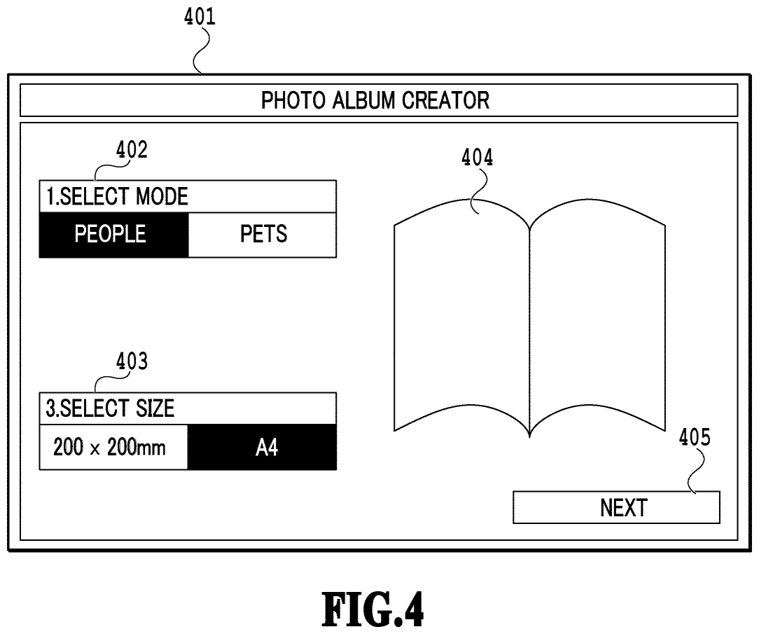

FIG. 4 illustrates an example of the product component selection screen 401 displayed at S301.

The mode selection list 402 allows the user to select one of a people mode (People) and a pet mode (Pets). In the people mode, photographs of people are preferentially selected from all the photographs selected by the user, and the selected photographs are laid out in the album. In the pet mode, photographs of pets or photographs of both pets and people are preferentially selected from all the photographs selected by the user, and the selected photographs are laid out in the album. In the example in FIG. 4, the people mode (People) is selected.

The size selection list 403 allows the user to select the size of the album. In the example of FIG. 4, from the selectable sizes of the 200×200 mm size and the A4 size, the A4 size is selected.

Based on the information selected in the mode selection list 402 and the size selection list 403, the album creation app 5 generates an album completion image 404 as a sample. In the case where the user makes a reselection from the mode selection list 402 or the size selection list 403, the album creation app 5 modifies the sample of the completion image 404 accordingly. For example, in the state illustrated in FIG. 4, in the case where the user changes the selection from the A4 size to the 200×200 mm size in the size selection list 403, the completion image 404 changes into a square completion image. Because this completion image 404 is a sample, actual images that the user has are not displayed in this completion image, but sample images are displayed.

In a case where the user clicks a decision (Next) button 405, the information selected on the product component selection screen 401 is fixed.

Although in the foregoing example, product components are selected using the mode selection list 402 and the size selection list 403, the present disclosure is not limited to this example. For example, the product component selection screen 401 may have a screen on which the user can select the design of an album or specifies the number of pages.

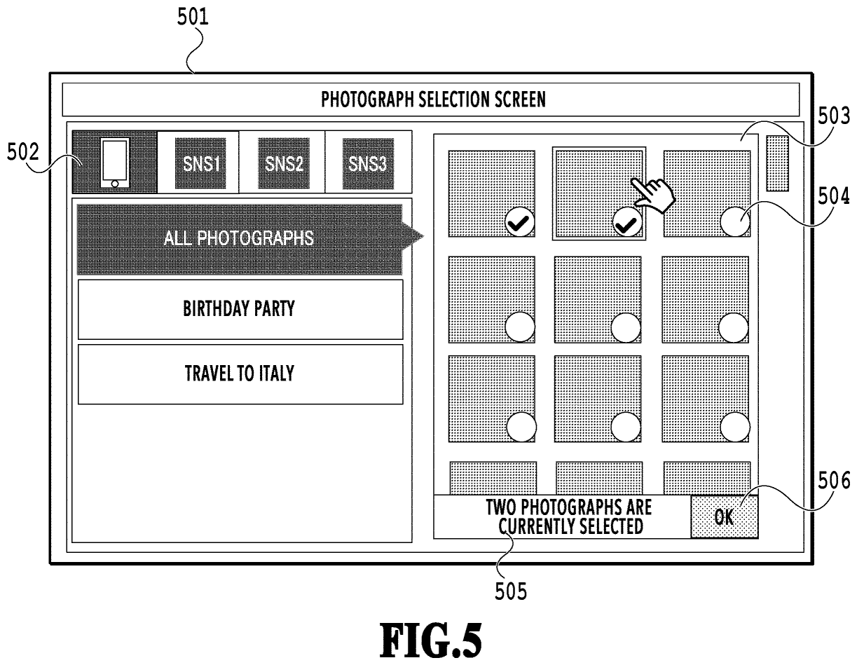

FIG. 5 illustrates an example of the photograph selection screen 501 displayed at S302. The screen transitions to the photograph selection screen 501 after the user selects the decision button 405 on the product component selection screen 401.

The user can select in the area 502 a photograph obtaining source from which photographs are to be obtained. As shown in the illustration, the user can select, for example, the terminal with which the user is operating the album creation app 5 or SNSs (social networking services) as a photograph obtaining source. Note that SNSs are systems (web-based service) through which users can transmit or receive information (images, comments, and the like) and share the information with other users via the Internet. In general, users use SNS applications installed in their terminals or web browsers that allow the user to transmit (post) information and browse information. Transmitted information is stored in an SNS server. In the case where the user selects the terminal, the user can further select all the photograph in the terminal or folders in the terminal. In the example of FIG. 5, two folder names, “BIRTHDAY PARTY” and “TRAVEL TO ITALY”, are displayed as selectable folders. In the example of FIG. 5, “ALL PHOTOGRAPHS” in the terminal are selected.

The area 503 displays the photographs included in the obtaining source selected in the area 502 in a thumbnail list form. In the example of FIG. 5, all the photographs in the terminal are displayed in the list form. The user can select photographs from the thumbnail list. In a case where a photograph is selected, a check mark appears in the check box 504 of the selected photograph.

The area 505 displays the total number of selected photographs.

In a case where the user selects the OK button 506, the photograph selection is completed.

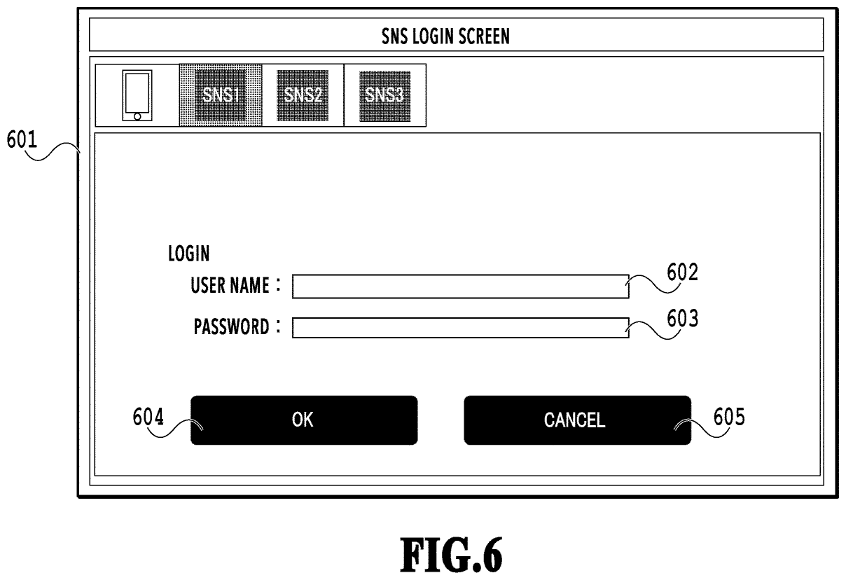

FIG. 6 illustrates an example of an SNS login screen in the present embodiment. The example of FIG. 6 illustrates an SNS login screen displayed for the case where SNS 1 is selected in the area 502 of the photograph selection screen 501.

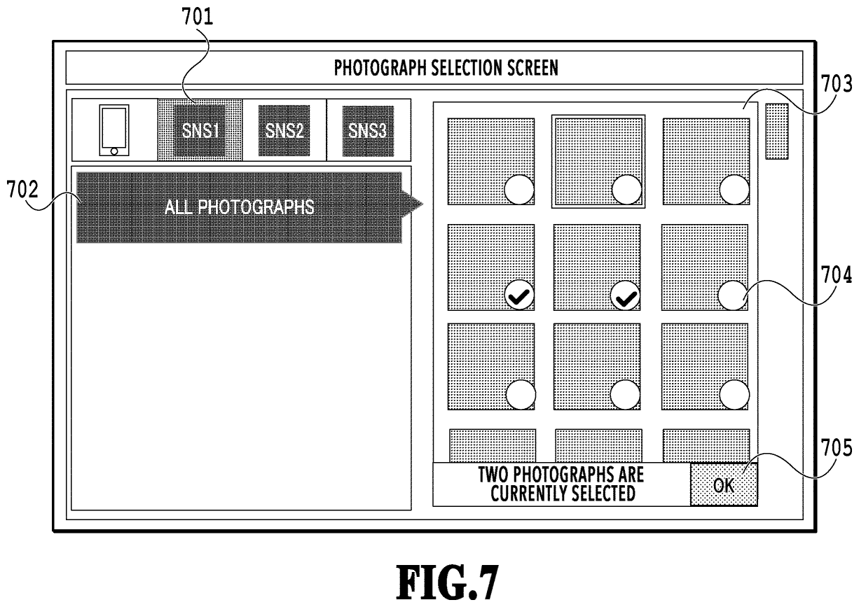

The area 601 corresponds to the login screen of SNS 1 selected in the area 502 of the photograph selection screen 501. This area allows the user to input the user name 602 and the password 603. In a case where the user selects the OK button 604, and the login is successful, the photograph selection screen illustrated in FIG. 7 appears.

On the other hand, in a case where the user selects the cancel button 605, the login is cancelled, and the screen goes back to the photograph selection screen of FIG. 5.

FIG. 7 illustrates another example of a photograph selection screen in the present embodiment. Specifically, the photograph selection screen of FIG. 7 appears after the user logged in SNS 1 and displays the photographs that the login user has posted on SNS 1, in a list form.

The area 701 shows photograph obtaining sources. In the example of FIG. 7, “SNS 1” is selected. The user can select, in the area 702, all the photographs in the obtaining source (which means SNS 1) or a folder in the obtaining source from the obtaining source selected in the area 701. In the example of FIG. 7, “ALL PHOTOGRAPHS” are selected.

The area 703 displays the photographs included in the specified location selected in the area 702 in a thumbnail list form. In the example of FIG. 7, all the photographs that the user has posted on SNS 1 are displayed in the list form. The user can select photographs from the thumbnail list. In a case where a photograph is selected, a check mark appears in the check box 704 of the selected photograph. The check mark allows the user to confirm the selected photographs.

In a case where the user selects the OK button 705, the photograph selection is completed, and the information processing apparatus 1 executes an image replacement process described below.

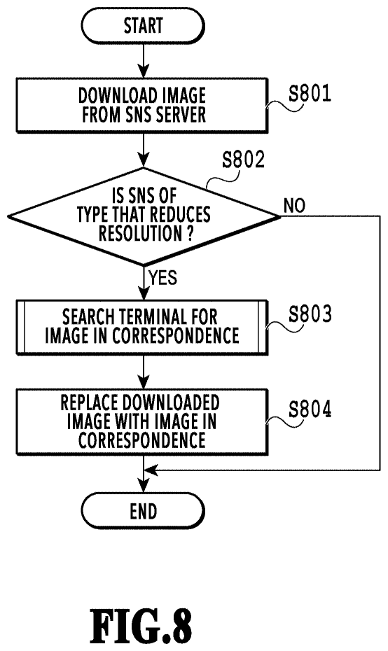

FIG. 8 is a flowchart showing the image replacement process in the present embodiment. Specifically, the process is executed after the user selects the OK button 705 in the state where SNS photographs are selected on the photograph selection screen of FIG. 7.

At 5801, the information processing apparatus 1 downloads the images selected in the photograph selection screen of FIG. 7 (in other words, the images that the user has selected on the social networking service) from a server apparatus (hereinafter also referred to as an SNS server) that provides the SNS.

At S802, the information processing apparatus 1 determines whether the SNS that is the downloading source of the images is a type of SNS that reduces the resolution of posted images. This is because there are SNSs that reduce the resolution of posted images and SNSs that do not. It is preferable that the determination whether it is a type of SNS that reduces the resolution be made based on a table stored in advance. The table has registered information in which multiple SNSs are associated with information pieces indicating whether each SNS is a type that reduces the resolution or a type that does not. Thus, the information processing apparatus 1 can refer to the table and determine whether the SNS is a type that reduces the resolution of posted images, based on information on the downloading source SNS (identification information such as the name). In a case where the SNS is an SNS of a type that reduces the resolution of posted images, the process proceeds to 5803. On the other hand, in a case where the SNS is an SNS of a type that does not reduce the resolution, the process is terminated.

At S803, the information processing apparatus 1 searches the information processing apparatus 1 (in other words, the terminal) for images that correspond to the downloaded images (in other words, images corresponding to the downloaded images).

It is often the case that photographs selected in an SNS are stored in the terminal that the user is using. For example, in the case where a user wants to post images that the user took during a travel to Spain onto an SNS, the user stores, in advance, images that the user took in the terminal with which the user is going to use for the SNS, and then the user selects desired images in the terminal and uploads them to the SNS. Thus, in the case where the terminal used for downloading images from the SNS with the album creation app 5 is the same as the terminal that was used for uploading the images to the SNS, there is a strong possibility that the terminal still has original images (in other words, the uploaded images) in it.

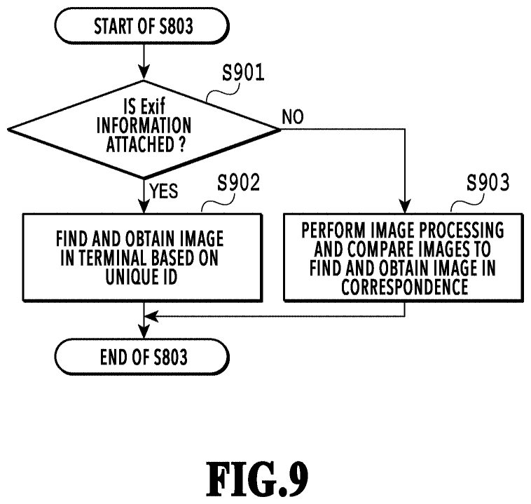

FIG. 9 illustrates a flowchart of the image search process in S803.

At S901, the information processing apparatus 1 determines whether a downloaded image has Exif information (whether Exif information is attached to the image). If the image has Exif information, the process proceeds to S902, but if not, the process proceeds to S903.

At S902, the information processing apparatus 1 obtains the unique ID (identifier) included in the Exif information of the downloaded image, finds an image within the terminal (in other words, within the information processing apparatus 1) having the unique ID that corresponds to the obtained unique ID, and obtains the image. The unique ID is one of the data pieces included in Exif information and is an identification code assigned to uniquely identify each image.

At S903, the information processing apparatus 1 performs image processing on the downloaded image and the images in the terminal to compare them. The information processing apparatus 1 determines an image in the terminal that corresponds to the downloaded image and obtains it. Examples of the image processing method include a method of measuring the level of similarity of images by deriving the hash values of the images using Perceptual Hashing and a method of measuring the level of similarity of images by calculating and deriving the correlation values of the images. Note that the image processing method is not limited to these examples but may be any method that makes it possible to determine an image in correspondence.

As an option to shorten the time required for the image processing, the information processing apparatus 1 may obtain the posting date of a posted image from the SNS and may narrow down searching of the images in the terminal to the images taken in a specified period set using the posting date as a reference before performing the image processing. This is because it is highly possible that after a user captured images, the user posts the images on an SNS before a long time has passed. For example, in the case where an image posted on November 3 needs to be searched for in the terminal, the information processing apparatus 1 obtains, from the inside of the terminal, images taken during the period from the day 5 days before November 3 to November 3 and performs image processing on those images. This shortens the processing time.

Returning to FIG. 8, the information processing apparatus 1, at S804, replaces the images downloaded from the SNS at S801 with the images in the terminal obtained at S803. Note that in the case where a corresponding image could not be obtained within the terminal at S803, it is impossible to replace the image downloaded from the SNS, and thus the information processing apparatus 1 keeps the image downloaded from the SNS.

As described above, in the case where images are downloaded from an SNS at the photograph selection in S302 in FIG. 3, it is possible that the downloaded images have lower resolution. In such a case, the downloaded images are replaced with corresponding images in the terminal, and then the process proceeds to S303.

As described above, in the case where there are images in the terminal that corresponds to the images downloaded from the SNS, the downloaded images are replaced with the images in the terminal, and thus, images the resolution of which has not been reduced due to posting to the SNS can be used for analysis. In other words, even in the case where the images downloaded from an SNS are used to create a photo album, the quality of the images in the photo album data is high.

### Second Embodiment

In the first embodiment, a method has been described for suppressing deterioration of the quality of images in a photo album by replacing images downloaded from the SNS with images in the terminal. In this embodiment, a method will be described that enables more accurate image analysis, with an attention on the analysis of the photograph information (Exif information) in S303 of FIG. 3. Specifically, in the case where Exif information of an image is deleted or modified in a case where the image was posted on the SNS, the image is replaced with an image in the terminal including the original Exif information to enable more accurate image analysis. In the following, description of parts common to those in the first embodiment is omitted, and parts different from those in the first embodiment are mainly described.

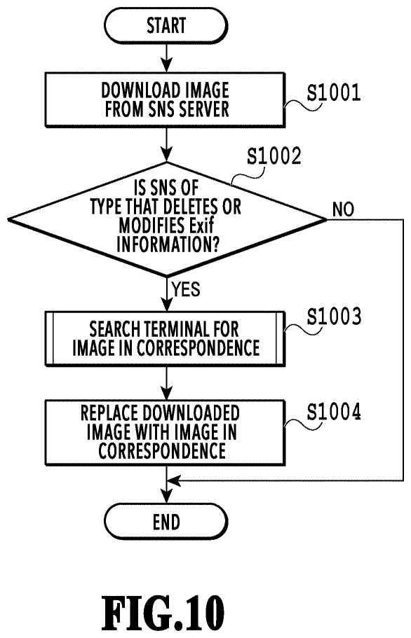

FIG. 10 is a flowchart showing an image replacement process in the present embodiment. Specifically, the process is executed after the user selects the OK button 705 in the state where SNS photographs are selected on the photograph selection screen of FIG. 7.

At S1001, the information processing apparatus 1 downloads the images selected on the photograph selection screen of FIG. 7 from the SNS server.

At S1002, the information processing apparatus 1 determines whether the SNS that is the downloading source of the images is a type of SNS that deletes or modifies Exif information of posted images. It is preferable that the determination whether it is a type of SNS that deletes or modifies Exif information of posted images be made based on a table that is stored in advance. The table has registered information in which multiple SNSs are associated with information pieces indicating whether each SNS is a type that deletes or modifies Exif information of posted images or a type that does not. Thus, the information processing apparatus 1 can refer to the table and determine whether the SNS is a type that deletes or modifies Exif information of posted images, based on information on the downloading source SNS (identification information such as the name). This is because there are SNSs that delete or modify Exif information of posted images and SNSs that do not perform such a process. In a case where the SNS is an SNS of a type that deletes or modifies Exif information of posted images, the process proceeds to S1003. On the other hand, in a case where the SNS is not of the type, the process is terminated.

At S1003, the information processing apparatus 1 searches the information processing apparatus 1 (in other words, in the terminal) for images that corresponds to the downloaded images.

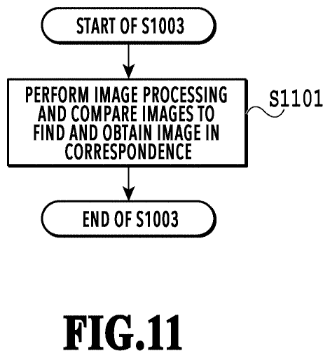

FIG. 11 illustrates a flowchart of the image search process in S1003.

At S1101, the information processing apparatus 1 performs image processing on the downloaded image and the images in the terminal to compare them. The information processing apparatus 1 determines an image in the terminal that corresponds to the downloaded image and obtains it. Examples of the image processing method include a method of measuring the level of similarity of images by deriving the hash values of the images using Perceptual Hashing and a method of measuring the level of similarity of images by calculating and deriving the correlation values of the images. Note that the image processing method is not limited to these examples but may be any method that makes it possible to determine an image in correspondence. As in S903 of FIG. 9, in order to shorten the time required for the image processing, the information processing apparatus 1 may obtain the posting date of a posted image from the SNS and may narrow down searching of the images in the terminal to the images taken in a specified period set using the posting date as a reference before performing the image processing.

Returning to FIG. 10, the information processing apparatus 1, at S1004, replaces the images downloaded from the SNS at S1001 with the images in the terminal obtained at S1003. Note that in the case where a corresponding image could not be obtained within the terminal at S1003, it is impossible to replace the image downloaded from the SNS, and thus the information processing apparatus 1 keeps the image downloaded from the SNS.

As described above, in the case where images are downloaded from an SNS at the photograph selection in S302 in FIG. 3, it is possible that Exif information of the downloaded images is deleted or modified. In such a case, the downloaded images are replaced with corresponding images in the terminal, and then the process proceeds to S303.

As described above, in the case where there are images in the terminal that corresponds to the images downloaded from the SNS, the downloaded images are replaced with the images in the terminal, and this enables more accurate image analysis by using the Exif information. Thus, even in the case where the images downloaded from the SNS are used to create a photo album, the quality of the images in the photo album data is high.

### Third Embodiment

In the first and second embodiments, images downloaded from the SNS (hereinafter also referred to as SNS images) are replaced with images in the terminal that corresponds to the downloaded images. However, in the case where downloaded images do not have Exif information, or in the case where the Exif information is modified, even the method of measuring the level of similarity of images by image processing cannot necessarily make it possible to find an image in correspondence. Hence, in the present embodiment, a process will be described for the SNS images to which image that corresponds (hereinafter also referred to as a correspondence image) could not be found and thus not be obtained. In the following, description of parts common to those in the first and second embodiments is omitted, and parts different from those in the first and second embodiments are mainly described.

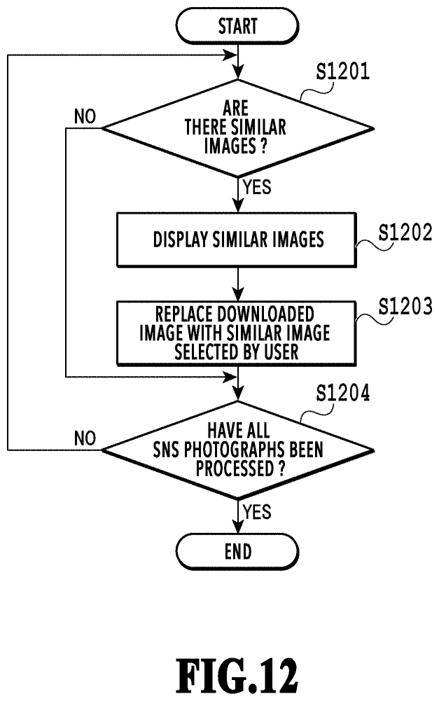

FIG. 12 illustrates a flowchart of a similar-image obtaining process in the present embodiment. This process can be performed, for example, on SNS images of which correspondence images could not be found at S903 of FIG. 9 or at S1101 of FIG. 11.

At S1201, the information processing apparatus 1 determine whether there is an image in the terminal (in other words, in the information processing apparatus 1) that is similar to an SNS image. The determination is made, for example, based on whether there is an image in the terminal the hash values of which are similar to those of the SNS image. Alternatively, the similarity determination may be made based on the correlation value of the images. Alternatively, the information processing apparatus 1 may obtain the posting date of the SNS image from the SNS and may search among images having a shooting date of the same date as the posting date or a date in a specified period before the posting date. If one or more similar images are found, the process proceeds to S1202, and if not, the process proceeds to S1204.

At S1202, the information processing apparatus 1 displays the one or more similar images.

At S1203, the information processing apparatus 1 replaces the SNS image with the image that the user selected as the correspondence image, from the one or more similar images displayed at S1202.

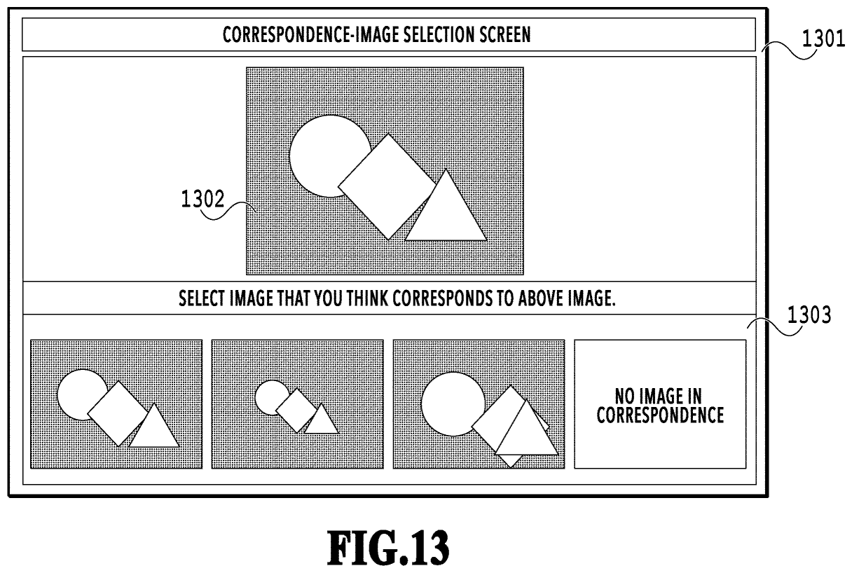

FIG. 13 illustrates an example of a correspondence-image selection screen 1301 in the present embodiment. The correspondence-image selection screen 1301 is displayed in the case it is determined at S1201 where there are similar images.

The image 1302 is the image that the user selected from the SNS and downloaded.

The area 1303 is for displaying images similar to the image 1302. The area 1303 allows the user to select an image that the user thinks corresponds to the downloaded image. In the case where there is no image that the user thinks corresponds to the down loaded image, the user selects “NO IMAGE IN CORRESPONDENCE” and uses the image downloaded from the SNS without replacing it.

At S1204, the information processing apparatus 1 determines whether the process has been performed on all the SNS images of which correspondence image could not be obtained. In the case where all the SNS images have not been processed, the processes from S1201 to S1203 are executed repeatedly. On the other hand, in the case where all the SNS images have been processed, the process is terminated.

As has been described above, even in the case where an correspondence image could not be found by image processing, it is possible to replace the SNS image with an image in the terminal by displaying similar images and the user selecting an image that the user determines corresponds to the SNS image, from the similar images. In other words, even in the case where the images downloaded from the SNS are used to create a photo album, the quality of the images in the photo album data is high.

Although the present embodiment has been described on the assumption that the process is executed on SNS images of which correspondence images could not be obtained, the process may be executed on all the SNS images of which Exif information has been deleted or modified. For example, the process in the present embodiment may be executed instead of S903 of FIG. 9 or S1101 of FIG. 11.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

The present disclosure suppresses degradation of image quality.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-128270, filed Jul. 10, 2019, which is hereby incorporated by reference wherein in its entirety.

What is claimed is:

1. A method of controlling an information processing apparatus, the method comprising the steps of:
downloading an image which a user selects on a social networking service, from a server apparatus that provides the social networking service;
replacing the downloaded image with an image that corresponds to the downloaded image and is stored in the information processing apparatus; and
analyzing the replaced image.

2. The method according to claim 1, further comprising the step of:
a first determination for determining whether the social networking service is a type of social networking service that reduces a resolution of a posted image;
wherein the replacing step replaces the downloaded image with the image that corresponds to the downloaded image in a case where the social networking service is the type of social networking service that reduces the resolution.

3. The method according to claim 2, wherein the replacing step finds the image stored in the information processing apparatus by using an identifier of the downloaded image.

4. The method according to claim 3, wherein the identifier is included in an Exif information.

5. The method according to claim 1, wherein in the case where the replacing step does not obtain the he identifier of the downloaded image, the replacing step performs image processing on the downloaded image and the images stored in the information processing apparatus to compare them and finds an image that corresponds to the downloaded image.

6. The method according to claim 5, wherein the image processing includes a process of deriving hash values or correlation values of the downloaded image and the image stored in the information processing apparatus.

7. The method according to claim 5, wherein the replacing step narrows down searching of images stored in the information processing apparatus based on a posting date of the downloaded image on the social networking service and thereafter performs the image processing.

8. The method according to claim 1, further comprising the step of:
a second determination for determining whether the social networking service is a type of a social networking service that deletes or modifies Exif information of a posted image,
wherein the replacing step replaces the downloaded image with the image that corresponds to the downloaded image in a case where the social networking service is the type of social networking service that deletes or modifies Exif information .

9. The method according to claim 8, wherein the replacing step performs image processing on the downloaded image and the images stored in the information processing apparatus to compare them and finds an image that corresponds to the downloaded image.

10. The method according to claim 9, wherein the image processing includes a process of deriving hash values or correlation values of the downloaded image and the image stored in the information processing apparatus.

11. The method according to claim 9, wherein the replacing step narrows down searching of images stored in the information processing apparatus based on a posting date of the downloaded image on the social networking service and thereafter performs the image processing.

12. The method according to claim 1, wherein the replacing step obtains similar images similar to the downloaded image in the case where an image corresponding to the downloaded image is not be found, and
replaces the downloaded image with an image which the user selects from the obtained similar images.

13. The method according to claim 12, wherein the replacing step performs image processing on the downloaded image and the image stored in the information processing apparatus to compare them and finds the similar image

14. The method according to claim 13, wherein the image processing includes a process of deriving hash values or correlation values of the downloaded image and the image stored in the information processing apparatus.

15. The method according to claim 13, wherein the replacing step narrows down searching of images stored in the information processing apparatus based on a posting date of the downloaded image on the social networking service and thereafter performs the image processing.

16. The method according to claim 1, further comprising the step of:
generating album data which lays out images, based on an analysis result of the analyzing step.

17. An information processing apparatus comprising:
a downloading unit configured to download an image which a user selects on a social networking service, from a server apparatus that provides the social networking service;
a replacing unit configured to replace the downloaded image with an image that corresponds to the downloaded image and is stored in the information processing apparatus; and
an analyzing unit configured to analyze the replaced image.

18. A non-transitory computer readable storage medium storing a program for causing a computer of an information processing apparatus to function as:
a downloading unit configured to download an image which a user selects on a social networking service from a server apparatus that provides the social networking service;
a replacing unit configured to replace the downloaded image with an image that corresponds to the downloaded image and is stored in the information processing apparatus; and
an analyzing unit configured to analyze the replaced image.
